(19) United States
(12) Patent Application Publication
(10) Pub. No.: US 2014/0355527 A1
(43) Pub. Date: Dec. 4, 2014

(54) SUPPORTING SIMULTANEOUS COMMUNICATION INTERFACES

(71) Applicant: BROADCOM CORPORATION, Irvine, CA (US)

(72) Inventors: Harish Vaidya, Bangalore (IN); Sriram Neelakandan, Bangalore (IN); Gireesh Hegde, Bangalore (IN); Rakesh Raman, Bangalore (IN)

(73) Assignee: BROADCOM CORPORATION, IRVINE, CA (US)

(21) Appl. No.: 13/923,806

(22) Filed: Jun. 21, 2013

Related U.S. Application Data
(60) Provisional application No. 61/828,882, filed on May 30, 2013.

(51) Int. Cl. H04W 76/02; H04W 72/08

(52) U.S. Cl. CPC H04W 76/025; H04W 72/085
USPC 370/329

(57) ABSTRACT

A system and method of creating more than one communication interface between a wireless device using a single, dual-radio transceiver by leveraging the basic service set (BSS) and radio measurement information. A wireless device operating in multiple-in, multiple-put (MIMO) mode maintains a first communications interface with an access point while establishing a second communications interface by downgrading the existing MIMO connection to a single-in, single-out (SISO) connection. The downgrading of the MIMO connection to a SISO connection frees up a radio signal processing chain to establish a second communications interface utilizing the BSS and radio measurement information from the first communications interface.

### CROSS-REFERENCE TO PRIORITY APPLICATIONS/INCORPORATION BY REFERENCE

The present U.S. Utility patent application claims priority pursuant to 35 U.S.C. §119(e) to the following U.S. Provisional Patent Application Ser. No. 61/828,882, entitled “Supporting Simultaneous Communication Interfaces,” filed May 30, 2013, pending, which is hereby incorporated herein by reference in its entirety and made part of the present U.S. Utility patent application for all purposes.

### BACKGROUND

1. Technical Field

The present disclosure described herein relates generally to wireless communications and more particularly to multiple interfaces in wireless communication devices.

2. Description of Related Art

Communication systems are known to support wireless and wire line communications between wireless and/or wire line communication devices. The communication systems range from national and/or international mobile/handheld systems to the point-to-point gaming, in-home wireless networks, audio, video wireless devices. Communication systems typically operate in accordance with one or more communication standards. Wireless communication systems operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, and other equivalents communicate directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

### BRIEF DESCRIPTION OF THE DRAWING(S)

FIG. 1 illustrates one embodiment of a communications network in accordance with the present disclosure;

FIG. 2 illustrates another embodiment of a communications network in accordance with the present disclosure;

FIG. 3 illustrates a multiple interface embodiment of the wireless communication system in accordance with the present disclosure;

FIG. 4 is a schematic block diagram of another embodiment of a wireless communication system in accordance with the present disclosure;

FIG. 5 illustrates an embodiment of the wireless communication system in accordance with the present disclosure; and

FIG. 6 illustrates another embodiment of the wireless communication system in accordance with the present disclosure.

### DETAILED DESCRIPTION

In one or more embodiments of the technology described herein, a system and method is provided to support simultaneous multiple interfaces in wireless communication devices.

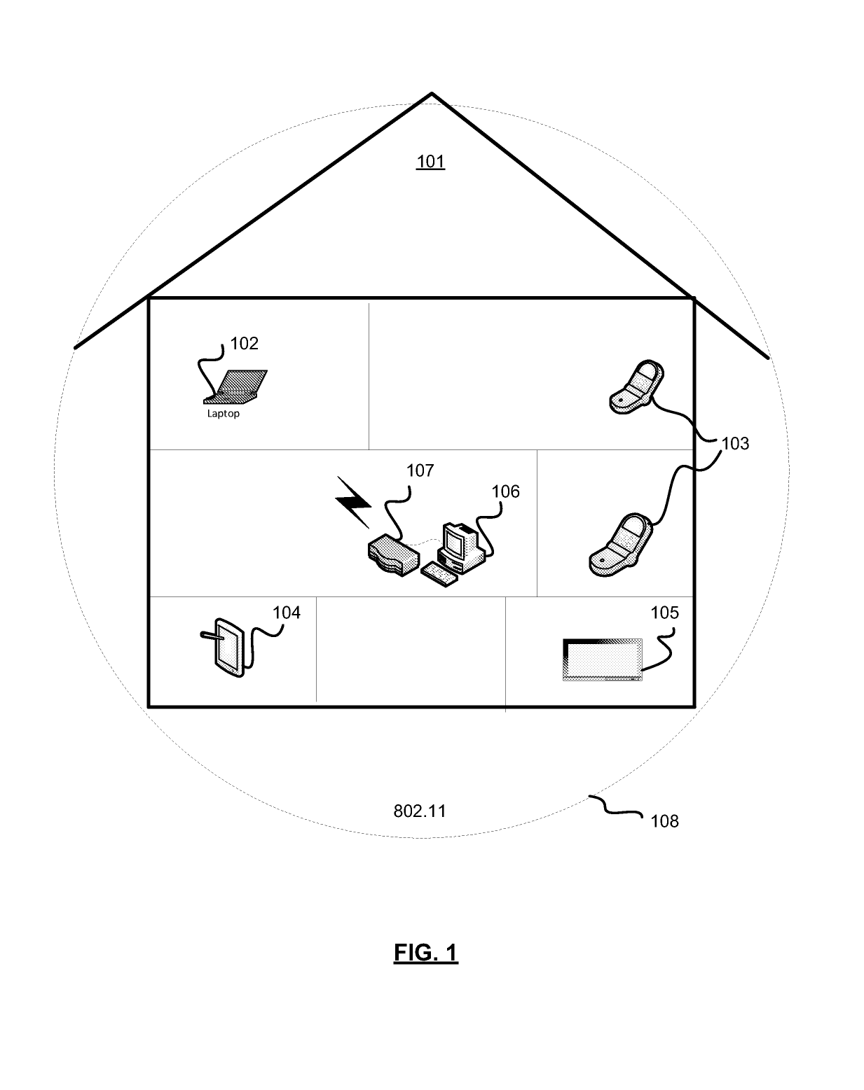

FIG. 1 illustrates one embodiment of a communications network in accordance with the present disclosure. As shown, FIG. 1 illustrates a home or building structure (premises) with one or more devices, wired or wireless, connected on a home network (802.11). A home or building structure (premises) 101 has one or more communication devices, wired or wireless (e.g., laptops 102, smart phones 103, tablets 104, web-enabled TVs 105, PCs 106, and other devices with wireless connectivity) connected on a home network. Internet services (e.g., broadband or high speed broadband) are communicatively connected to an access point 107 over wired (e.g., telephone, fiber, satellite, or cable) or wireless (e.g., 3G, 4G, etc.) networks. Access point 107 (e.g., a wireless router), connected, for example, to a PC 106 or Wi-Fi hotspot, will manage connection of the various devices to the internet using the 802.11ac protocol 108. However, other variations of the 802.11 standard can be used without departing from the scope of the technology described herein.

The 802.11 infrastructure network, such as the previously described home network, forms a wireless local area network (WLAN) which is distinguished by the use of the access point. Access points are used for all communications in the infrastructure network. The access point sends its capabilities in beacon frames or probe response frames. A beacon frame is a frame that is periodically transmitted by the access device to announce its availability. Alternatively, a probe response frame is a frame sent from the access point in response to a probe request frame sent from a communications device. The probe response frame provides capability information, supported data rates and other access point details pertaining to the WLAN. Included in the frame information is an indication whether the access point is Multiple-input, Multiple-output/Single-input, Single-output (MIMO/SISO) capable (a communications structure using multiple antennas or a single antenna to transmit and receive).

In one or more embodiments of the technology described herein, the communication devices can be personal computers, laptops, PDAs, smartphones, mobile phones, such as cellular telephones, devices equipped with wireless local area network or Bluetooth transceivers, FM tuners, TV tuners, digital cameras, digital camcorders, wireless printers, or other devices that either produce, process or use audio, video signals or other data or communications.

In operation, the communication devices include one or more applications that include voice communications such as standard telephony applications, voice-over-Internet Protocol (VoIP) applications, local gaming, Internet gaming, email, instant messaging, multimedia messaging, web browsing, audio/video recording, audio/video playback, audio/video downloading, playing of streaming audio/video, office applications such as databases, spreadsheets, word processing, presentation creation and processing and other voice and data applications.

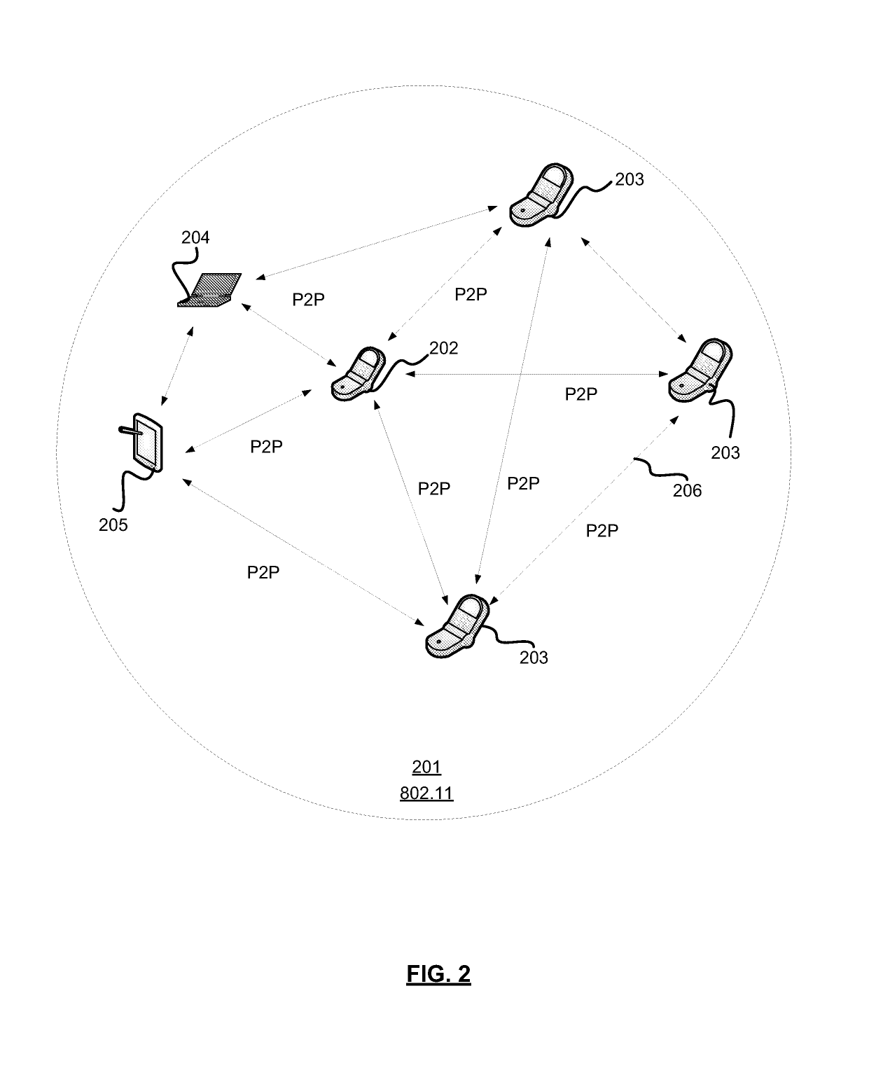

Unlike the home network, a peer-to-peer (P2P) network is one in which each communications device in the network can act as a client or server for the other devices in the network, allowing shared access to various resources such as files, peripherals, and sensors without the requirement for a central server or dedicated Internet access point. Peer-to-peer networks can be used for sharing content such as audio, video, data, or anything in digital format. Various embodiments as described in association with FIGS. 2-6 will incorporate peer-to-peer connections.

FIG. 2 illustrates another embodiment of a communications network in accordance with the present disclosure. As shown in FIG. 2, a peer-to-peer (P2P) group 201 includes various wirelessly connected devices, for example, cell phone(s) 202 and smart phone(s) 203(3), laptop(s) 204, tablets 205, and other devices with wireless communications capabilities. Each of the wireless devices can form direct peer-to-peer connections without communicating through an access point first. When connected to the peer-to-peer group, each device represents an individual peer within that peer-to-peer group. A group owner (GO), for example cell phone 202, will control connection of the various devices in the group using, for example, but not limited to, the 802.11(N) protocol (where N represents any version of the 802.11 standard, e.g., 802.11g, 802.11n, 802.11ac, etc.). In one embodiment, each peer initiates a Tunneled Direct Link Setup (TDLS) 206 for direct communication between peer devices in the group. In alternative embodiments, the peer-to-peer network also includes one or more nodes capable of cross-connecting to another network. For example, Internet services (e.g., broadband or high speed broadband) can, in some embodiments, be provided to one or more communication devices using broadband Internet access from, e.g., telephone, fiber, satellite, cellular or cable networks (e.g., 3G, 4G, etc.).

In one embodiment, in accordance with the present disclosure, wireless device technology includes creation of multiple wireless communications interfaces (connections) with more than one device. For example, wireless devices having a dual-radio transceiver establishes a first communications interface with an access point and a second communications interface with another wireless device through, for example, a direct peer-to-peer type connection. In one embodiment of the technology described herein, the transceiver is operable to switch between MIMO and SISO without sacrificing the first communications interface with an access point.

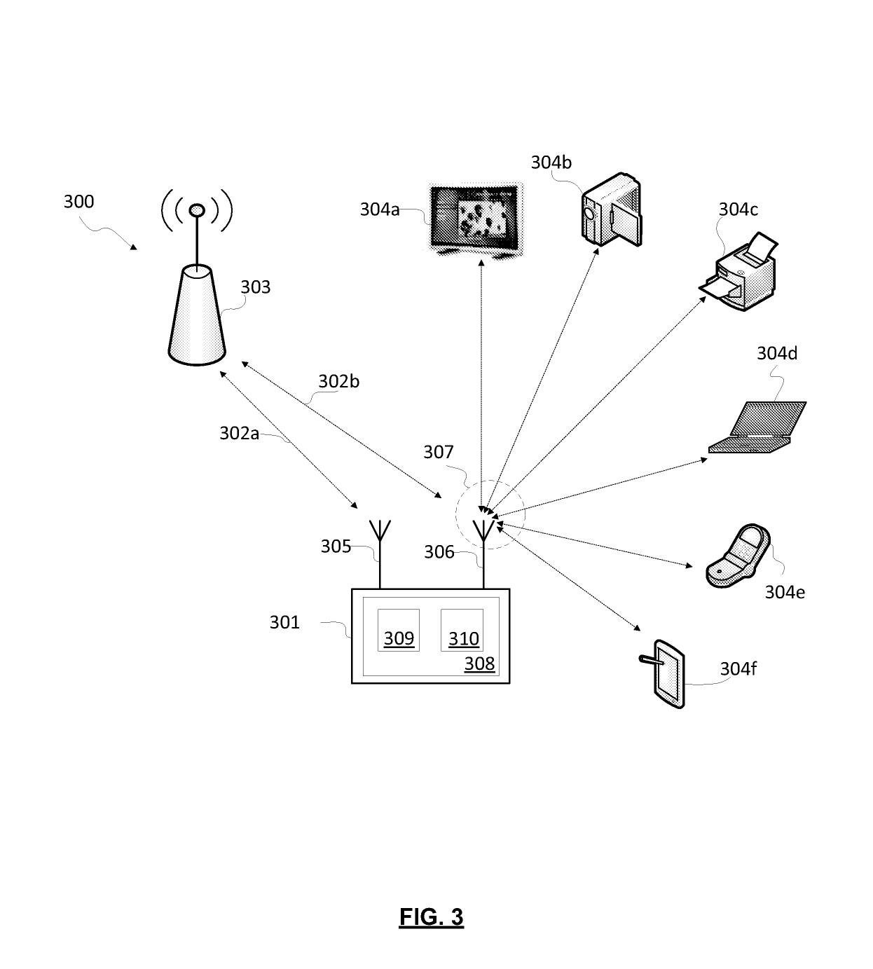

FIG. 3 illustrates a multiple interface embodiment of the wireless communication system in accordance with the present disclosure. System 300 includes a wireless communications device (e.g., a dual-radio tablet) 301 having a first communications interface from antenna 305 through wireless MIMO connection (302a and 302b) with access point 303 for accessing, for example, the Internet. Wireless communications device 301 is also connected, in a second communications interface through antenna 306, to one or more wireless enabled devices 304a through 304f through direct P2P connections 307. Wireless communications device 301 includes one or more transceiver modules 308 with two or more radio signal processing chains 309/310 (i.e., sequence of connected transmitter/receiver components (amplifiers, filters, mixers, converters, etc.)) capable of switching from MIMO to SISO. In order for communications device 301 to create the second communications interface, the first communications interface with access point 303 is switched from MIMO to SISO mode (302a only) to free up (idle) both a radio signal processing chain (e.g., 310) as well as its associated antenna 306. Radio signal processing chain 310 and antenna 306 can now be used (activated) to create the direct P2P connection with one or more wireless enabled devices 304a through 304f. The second communications interface, in this example, using a P2P connection through antenna 306, is established by leveraging shared (common) basic service set (BSS) configuration and radio measurement data (discussed in greater detail hereafter).

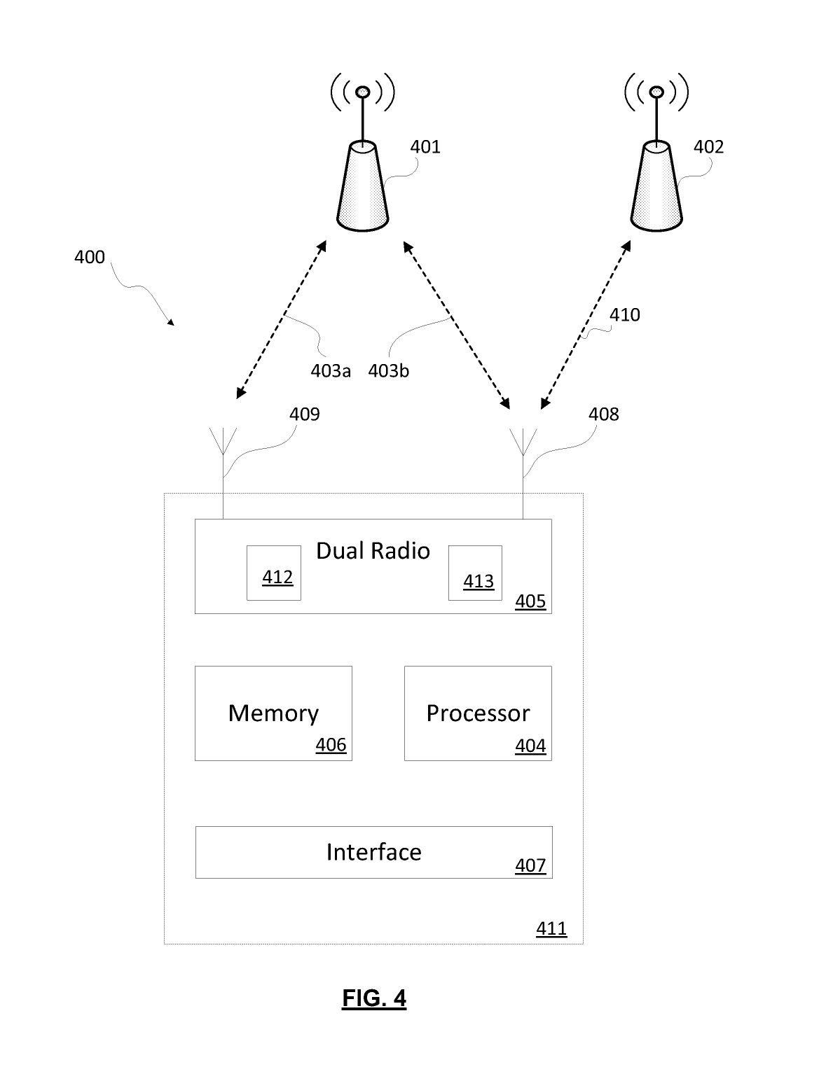

FIG. 4 is a schematic block diagram of another embodiment of a wireless communication system in accordance with the present disclosure. Wireless communication system 400 provides for a MIMO connection (403a and 403b) between access point 401 and wireless communications device 411. Wireless communications device 411 includes dual-radio transceiver module 405 with multiple signal processing chains 412/413 for processing multiple radio signal streams. In addition, processor module 404 with memory 406 and interface module 407 process both communication and non-communication functions of the wireless communications device (e.g., switching of transceiver from MIMO to SISO), store communication and non-communication data (e.g., collected BSS and radio measurements) and interface to include processing of visual and non-visual external and internal processed data. Wireless communications device 411 is in communication with access point 401 through first MIMO communications interface (403a and 403b) from dual-radio transceiver 405. Dual-radio transceiver 405 of wireless communications device 411, with two or more radio signal processing chains 412/413, is capable of switching (as directed by processor module 404) between a MIMO connection 403a/403b using both antennas 408 and 409 to a first SISO connection 403a through antenna 409 and second SISO connection 410 to another access point (shown) or wireless communications device 402 using antenna 408.

In a typical wireless environment, background scans are periodically performed by the wireless communications device 411 in communication with one or more surrounding access points (e.g., 402) to check the network capabilities. In one embodiment, the communications device dual-radio transceiver 405 downgrades from MIMO to SISO upon receiving a request for a background scan, freeing up (idling) a radio signal processing chain (e.g., 413) to perform the requested background scan through second communications interface 410 connecting radio chain 413 through antenna 408 to access point 402. The first communication interface between dual-radio transceiver 405 and access point 401 is maintained through radio signal processing chain 412 while a second communication interface between radio chain 413 and access point 402 is created. In alternative embodiments, several secondary communication interfaces are established consecutively between dual-radio transceiver 405 and other access points within range.

In one embodiment, radio signal processing chains 412/413 for the dual-radio transceiver 405 are controlled using action frames. For example, the access point 401 transmits an action through a frame body of a data link to a MIMO capable wireless communications device 411 indicating a downgrade of the MIMO connection is required. The processor of the wireless communications device implements the action frame request and downgrades the MIMO dual-radio transceiver link to SISO, freeing up (idling) a chain for a second communications interface.

In alternative embodiments, wireless communications device 411 initiates a request to downgrade the dual-radio transceiver MIMO connection (403a and 403b) in order to free up (idle) a radio signal processing chain (e.g., 413) in dual-radio transceiver 405 for physical layer (PHY) calibrations. In a typical wireless environment, PHY calibrations are periodically performed by the wireless communications device 411 in communication with the access point 401 to determine operating conditions and adjust the transmission, if necessary. The first communications interface between wireless communications device 411 and access point 401 is maintained while avoiding data stream disruptions.

In one embodiment, the basic service set (BSS) configuration and radio measurements of the first communications interface are shared prior to creating the second communications interface. The BSS configuration information provides, for example, channel, operating band, bandwidth and country details of existing wireless interface. Radio measurements include beacon positioning, channel load and medium sensing information to avoid overlapping beaconing scenarios and reduce channel interference. The BSS configuration and radio measurements from the first communications interface are used in the creation of the second communications interface to transmit data streams from the radio chain to the access point without having to use, for example, a separate channel or different bandwidth from the first communications interface. By leveraging the existing configuration for the first communications interface in the second communications interface, disruptions in the primary data stream are avoided.

In alternative embodiments, only the applicable collected BSS configuration and radio measurement information from the first communications interface is used to create the second communications interface. For example, a second 2.4 GHz wireless communications device is not capable of processing, for example, a 5 GHz signal and as a result, the second communications interface is created using only the remaining, applicable BSS configuration and radio measurement information from the first communications interface.

In one embodiment, network information of a first communications interface, such as channel specification (i.e., operating band, channel, bandwidth, etc.) is used intelligently by a wireless communications device to provide a better user experience. For example, using a virtual simultaneous dual band (VSDB) communications device to establish a point-to-point group owner (P2P-GO) second communications interface, the second communications interface is created in the same band, but a channel different from the first communications interface between the VSDB device and the access point. The second communications interface utilizing the same band, but different channel, reduces band-switch latency. For yet another example, in a real simultaneous dual band (RSDB) device entitled to establish a P2P-GO second communications interface, the second communications interface is created in a different band to insure optimal usage of hardware resources.

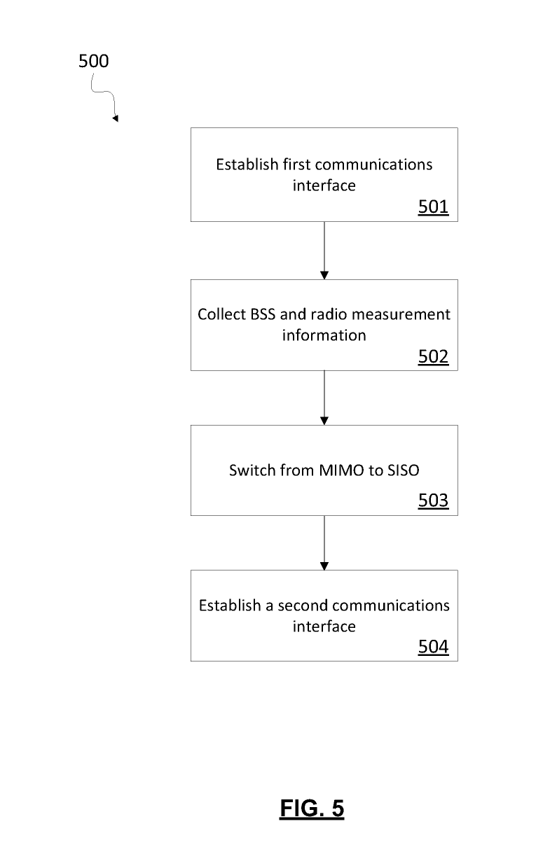

FIG. 5 illustrates an embodiment of the wireless communication system in accordance with the present disclosure. Process 500 begins with a wireless communications device establishing a first communications interface with, for example, an access point in step 501. The BSS configuration and radio measurement information from the first communications interface is collected in step 502 by the wireless device. The wireless communications device is in communication with the access point through a first communications interface in MIMO operation. All radio signal processing chains of the MIMO data stream are currently occupied with data streams transferring data to and from the wireless device and the access point. In step 503, the MIMO data stream is switched to a SISO to free up (idle) at least one radio signal processing chain for other communications. Using the freed up (idled) radio signal processing chains, a second communications interface is created with the BSS configuration and radio measurement information from the wireless communications device's first communications interface in step 504.

In another embodiment, the second communications interface is terminated when the second communications interface is no longer required. The wireless communications device is switched back from the SISO connection to a MIMO connection for the first communications interface.

In another embodiment, a MIMO wireless communications device downgrades the first communications interface between the wireless communications device and an access point to free up one radio chain that is used to establish a direct P2P connection. For example, a first wireless communications device is connected using MIMO to an access point for streaming content from a network. The first wireless communications device is capable of sharing the contents with a second wireless communications device using industry standards such as Wi-Fi-33 Direct or other proprietary non-infrastructure sharing schemes. When the P2P connection (second communications interface) is initiated, the first wireless communications device downgrades the MIMO data stream currently transmitting and receiving data from the access point into a SISO data stream, freeing up a radio chain. The freed (idled) radio signal processing chain is used to establish a P2P connection with the second wireless device to pass the streaming content to the second communications device.

In an alternative embodiment, a wireless MIMO capable communications device is used to implement an intelligent dual-radio soft access point. For example, the wireless MIMO communications device has a 2.4 GHz first communications interface to an access point. In one embodiment, the soft access point identifies that all of the connected devices are 5 GHz capable and, as a result, the soft access point shares the channel/band switch announcement to the connected devices and moves them to 5 g GHz. The soft access point transmits a notification to the connected devices to utilize the already established band. In another embodiment, the soft access point identifies non-5 GHz capable devices joining the network (e.g., legacy device) by transmitting beacon frames at 2.4 GHz. Upon the joining of a non-5 GHz capable device, the soft access point switches from 5 GHz MIMO operation to 2.4 GHz SISO+5 GHz SISO operation to accommodate for the two channels.

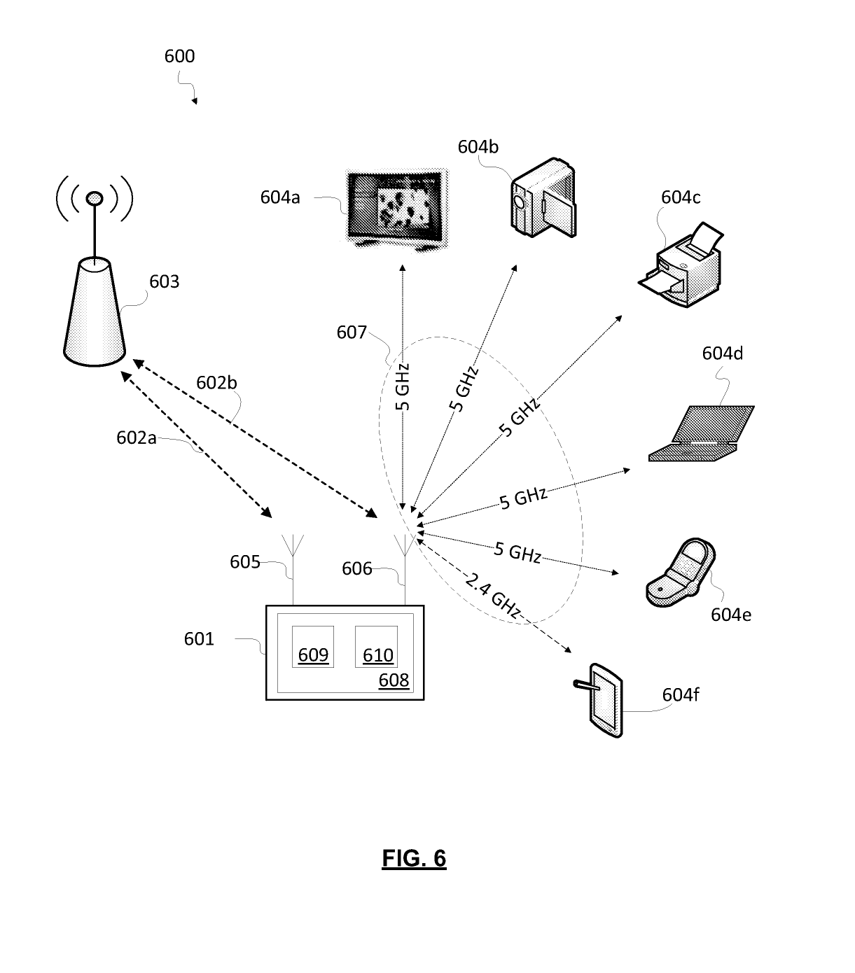

FIG. 6 illustrates another embodiment of the wireless communication system in accordance with the present disclosure. System 600 comprises a wireless communications device (e.g., dual-radio tablet) 601 having a first MIMO communication interface (602a and 602b), transmitted/received through antennas 605 and 606, with access point 603. Dual-radio tablet 601 provides for at least one transceiver 608 with two or more radio signal processing chains (609/610) operable to switch from MIMO to SISO and implement an intelligent soft access point. Wireless enabled devices 604a through 604f are shown and capable of creating a direct P2P connection with dual-radio tablet 601. In order for dual-radio tablet 601 to create a second communications interface 607 for a direct P2P connection with at least one of wireless enabled devices 604a through 604f, the first communications interface with access point 603 must be switched from MIMO to SISO to free up a radio signal processing chain (e.g., 610) for creating a soft access point for the direct P2P connection. Antenna 606, having been freed up (idled) by switching the first communication interface to SISO (602a) only, is available to serve as a soft access point for second communication interface 607 for the direct P2P connection with wireless devices 604a through 604f. Dual-radio tablet 601 transmits periodic beacon frames to determine the device capabilities of the wireless enabled devices currently in P2P connection with dual-radio tablet 601. In one embodiment, dual-radio tablet 601 transmits periodic beacon frames on a different channel than the established P2P channel. For example, the existing P2P network is established at 5 GHz so dual-radio tablet 601 transmits beacon frames at 5 GHz for the existing P2P devices 604a-604e as well as another channel to identify other devices 604f operating at 2.4 GHz (i.e., legacy devices).

In another embodiment, dual-radio devices according to the technology described herein also support features such as error correction and a capability to support simultaneous wireless connections to two wireless enabled devices. For example, a smart TV simultaneously accesses Internet content and streams high-bandwidth video from a smartphone, tablet or PC. In one embodiment, the P2P transmissions occur in the 5 GHz frequency band, with more spectrum and less congestion in that frequency range allowing better quality video streaming and smartphone-to-TV video sharing.

In yet another embodiment, the technology described herein operates for wireless communication devices such as, but not limited to, Bluetooth, remotes, game controllers, stereo headphones, keyboards, 3D glasses and other devices. In related embodiments, these wireless communication devices have the ability to stream audio to home stereos, enable voice recognition in remote controls and connect smartphones and other devices to a wireless ecosystem.

Comparative advantages include, but are not limited to: elimination of the first communications interface failure that afflicts direct peer-to-peer networks; power saving techniques at the 802.11 layer 2 resulting in increased battery life and since close-proximity peer network applications are targeted, complicated multi-hop routing protocols (and related latency and bandwidth degradation) are avoided.

While the disclosure describes a first interface as a connection to an access point and a second interface as a P2P connection, the interfaces are not limited thereto. Other known and future communication techniques are envisioned without departing from the scope of the technology described herein. For example, the interfaces can be A_{P}/AP, P2P/P2P, BS/P2P (base station/P2P), etc. In addition, while described for peer-to-peer (P2P), other connections are envisioned such as any adhoc connection (e.g., an independent basic service set (IBSS)). Also, while shown for a two antenna device, any number of antennas can be used without departing from the scope of the technology described herein.

In one or more embodiments the technology described herein the wireless connection can communicate in accordance with a wireless network protocol such as Wi-Fi, WiHD, NGMS, IEEE 802.11a, ac, b, g, n, or other 802.11 standard protocol, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the communication device

Throughout the specification, drawings and claims various terminology is used to describe the various embodiments. As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

In an embodiment of the technology described herein, receiver and transmitter processing modules are implemented via use of a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. In some embodiments, the associated memory is a single memory device or a plurality of memory devices that are either on-chip or off-chip. Such a memory device includes a read-only memory, random access memory, volatile memory, non-volatile memory, static memory, dynamic memory, flash memory, and/or any device that stores digital information. Note that when the processing devices implement one or more of their functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The technology as described herein has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed technology described herein. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed technology described herein. One of average skill in the art will also recognize that the functional building blocks, and other illustrative blocks, modules and components herein, can be implemented as illustrated or by discrete components, application specific integrated circuits, processors executing appropriate software and the like or any combination thereof.

The technology as described herein may have also been described, at least in part, in terms of one or more embodiments. An embodiment of the technology as described herein is used herein to illustrate an aspect thereof, a feature thereof, a concept thereof, and/or an example thereof. A physical embodiment of an apparatus, an article of manufacture, a machine, and/or of a process that embodies the technology described herein may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

While particular combinations of various functions and features of the technology as described herein have been expressly described herein, other combinations of these features and functions are likewise possible. The technology as described herein is not limited by the particular examples disclosed herein and expressly incorporates these other combinations.

1. A method of creating multiple communication interfaces in a first wireless device, the method comprising:
establishing a first communications interface between the first wireless device and an access point;
collecting basic service set (BSS) and radio measurement information of the first communications interface; and
establishing a second communications interface from the first wireless device to a second wireless device by sharing the collected BSS and radio measurement information.

2. The method of claim 1, wherein the first communications interface is a multiple-in, multiple-out (MIMO) connection, the method further comprising switching the MIMO connection of the first communications interface to a single-in, single out (SISO) connection before establishing the second communications interface.

3. The method of claim 2, wherein the second communications interface comprises a SISO connection and is used for periodic background scans of one or more surrounding access points to check network capabilities.

4. The method of claim 2, wherein the second communications interface is used for conducting PHY calibrations of the access point.

5. The method of claim 1, wherein the established second communications interface is a peer-to-peer (P2P) or independent basic service set (IBSS) connection between the first wireless device and the second wireless device.

6. The method of claim 1, wherein the first wireless device comprises at least a transceiver with multiple radio signal processing chains.

7. The method of claim 6, wherein a first of the multiple radio signal processing chains is used to maintain the established first communications interface while utilizing a second of the multiple radio signal processing chains to establish the second communications interface.

8. The method of claim 1, wherein the basic service set information includes one or more of: channel, band, bandwidth and country information.

9. The method of claim 1, wherein the radio measurement information includes one or more of: beacon positioning, channel load and medium sensing.

10. The method of claim 1, wherein the common collected BSS and radio measurement information of the first communications interface is determined by applicable capabilities of the second wireless device.

11. A method of creating multiple communication interfaces in a first wireless device, the first wireless device comprising a transceiver with a plurality of radio signal processing chains, the method comprising:
establishing a first communications interface with a first communication structure using two or more of the plurality of radio signal processing chains;
collecting basic service set (BSS) and radio measurement information of the first communications interface; and
switching from the first communication structure to a second communication structure to idle one or more of the plurality of radio signal processing chains;
establishing a second communications interface from the first wireless device to a second wireless device by sharing the collected BSS and radio measurement information and the idled one or more radio signal processing chains of the first communications interface.

12. The method of claim 11, wherein the first communications interface with a first communication structure is a multiple-in, multiple-out (MIMO) connection and the second communication structure is a single-in, single out (SISO) connection and the switching step comprises switching the first communications interface from MIMO to SISO before establishing the second communications interface.

13. The method of claim 12, wherein the first communications interface is maintained with the SISO connection while establishing the second communications interface.

14. The method of claim 11, wherein the established second communications interface is a peer-to-peer (P2P) or independent basic service set (IBSS) connection between the first wireless device and the second wireless device.

15. A wireless device comprising:
at least one transceiver with multiple radio signal processing chains processing a first communications connection;
two or more antennas connected to the at least one transceiver;
multiple radio signal processing chains transmitting and receiving radio signals through the two or more antennas and the first communications connection;
a processing module, coupled to the at least one transceiver, selectively idling at least one of the multiple radio signal processing chains and one of the two or more antennas, the idled at least one of the multiple radio signal processing chains and one of the two or more antennas subsequently activated to establish a second communications connection to another wireless device while maintaining the first communications connection.

16. The wireless device of claim 15, wherein the first communications connection is maintained by at least one of the multiple radio signal processing chains and one of the two or more antennas not idled.

17. The wireless device of claim 15, wherein the processing module coupled to the at least one transceiver collects and stores in memory connection information from the first processed communications connection, the stored connection information selectively leveraged to establish the second communications connection.

18. The wireless device of claim 15, wherein the first communications connection is to a remote access point and the established second communications connection is a peer-to-peer (P2P) or independent basic service set (IBSS) connection between the wireless device and the another wireless device.

19. The wireless device of claim 15, wherein the first communications connection is a multiple-in, multiple-out (MIMO) connection and the second communications connection is a single-in, single out (SISO) connection and the selective idling comprises switching the first communications connection from MIMO to SISO before establishing the second communications connection.

20. The wireless device of claim 19, wherein the MIMO connection comprises a 5 GHz MIMO connection and, after the switching and establishing second communications connections, comprises two SISO connections comprising any or a combination of: 2.4 GHz SISO and 5.0 GHz SISO.
